(19) United States
(12) Patent Application Publication
(10) Pub. No.: US 2015/0353261 A1
(43) Pub. Date: Dec. 10, 2015

(54) Two-step processing method for preparing starch based food products

(71) Applicant: Vijai Prakash Gupta, Berwyn, PA (US)

(72) Inventor: Vijai Prakash Gupta, Berwyn, PA (US)

(21) Appl. No.: 14/545,707

(22) Filed: Jun. 8, 2015

Related U.S. Application Data
(60) Provisional application No. 61/997,776, filed on Jun. 10, 2014.

(51) Int. Cl. B65D 81/34; A23L 1/16; A23L 1/212; A23L 1/182

(52) U.S. Cl. CPC B65D 81/34; A23L 1/182; A23L 1/16; A23L 1/2123; A23V 2002/00

(57) ABSTRACT

A method for preparing a shelf-stable starch based food product. The method includes introducing a quantity of a starch based ingredient and other ingredients including water, as required by a recipe, in a container. The method further includes sealing the container with a volume of one or more gases present therein such that the volume of one or more gases is based on the quantity of the ingredients. The method also includes processing the container, at a first temperature and a first pressure, for substantially cooking the ingredients, and further processing the container, at a second temperature and a second pressure, for substantially sterilizing the contents, including the ingredients and gases, inside the container.

### TECHNICAL FIELD

The present disclosure pertains to a method for preparing shelf-stable starch based food products, and more particularly pertains to a method involving two-step processing for preparing improved starch based food products with lesser or no sticking and lumping of the ingredients.

### BACKGROUND

A variety of ready to eat, shelf-stable, also known as ‘retorted’ food products, are available commercially. Retorted food products available in such shelf-stable packages are of different variety, styles and content. Retorted food products include starch based products, such as rice or pasta, for example, spaghetti, macaroni, ziti and the like. Generally retorted food products are prepared by packing the ingredient items in a retort container and then thermally processing the container. In particular, such food products are prepared by placing all the ingredients, including water, in the container; sealing the container according to the container design and processing the sealed container for concurrent cooking and sterilizing of the food product therein. The processing usually takes place in retort vessels for commercial production. The ingredients get cooked at the same time while being sterilized in the retort vessel. Sometimes partially or fully cooked food items are packed and then retorted for sterilization. These food products are generally processed at high temperatures, typically in the range of 240-260° F. which is required for commercial sterilization. Further this process usually takes place at high pressure typically in the range of 25-45 psig external pressure in the retort vessel.

As the processing continues, the water in the container gets gradually absorbed by the solid starch based ingredients, while at the same time some starch and other components leach out into the free water inside the container. This causes the water phase to get increasingly thicker and sticky, like a starch solution in water. Further because of the high external pressure involved in the process, the typically employed flexible pouch as the container gets compressed reducing the free space inside the container. The stickiness of the free water and the space restriction created by the external overpressure, causes considerable bonding and clumping of the starch based ingredients inside the container. The longer exposure to high retort temperature used for sterilization also contributes to more sticking of the starch based ingredients, just as it happens in the bottom of a pan on a stove top if the heat is not reduced to low after all the water is nearly absorbed.

In known retorting methods, no effort is made to provide adequate headspace for the particles to swell while cooking inside the container. Further the packed air volume is usually not sufficient to fill voids between the particles, as the particles swells. This results in the final food product having a lumpy texture with some particulates sticking to each other. Most of such commercially available products of starchy foods like rice, feel like a solid bar, unopened, and the opened contents feel like lumps mixed with separate particles. Such food products when taken out of the container look less attractive than similar food product prepared carefully in a household or any restaurant. Some techniques have been devised in the prior-art that attempts to reduce this sticking of the food particulates and the lumpy texture of the food product inside the container.

Some processors wash the starch ingredients to remove the free powder starch present on its surface, then blanch the food product, drain the blanching water, add oils and any needed seasoning, then fill the mix in the retort package. This blanching step may reduce, lumpy texture to some extent but removes a lot of the food product's flavor and nutrients with the drained water. The filling of the container with partially cooked blanched food product is also difficult compared to dry ingredients. Earlier processes of the food retorting also include preparing fully-cooked starch product in open top kettles, much like at home cooking, combining the pre-cooked product with other ingredients like vegetables, beans and seasoning, filling the mixture in cans, and sealing and retorting the cans for shelf storage. However these processes have issues like filling of pre-cooked product in flexible pouches is difficult, and also cooking in open top kettles is usually done in small batches, which is uneconomical.

U.S. Pat. No. 1,634,332 describes a process for preparing spaghetti. The disclosed process provides that all ingredients are put together into a rigid metal can, without any prior cooking of the spaghetti noodles. After that either one or two stages of heating are carried out to cook and sterilize the spaghetti. A large amount of sauce is used “to cause the spaghetti strands to move and slip and slide over each other, while cooking” with “agitation, motion or shaking while the contents are being cooked”. The space between the spaghetti strands is filled with a thin sauce. It is to be noted that a typical good plate of freshly made spaghetti has over 50% void volume before any sauce or other components are added. The disclosed process provides spaghetti products with large amounts of thin sauce to keep the strands from sticking to each other, which does not resemble a normally prepared spaghetti dish. In this process, no effort is made to provide adequate free air space to fill the voids between the spaghetti noodles, and instead the final product is mostly filled with sauce. Adding a lot of sauce might keep the particulates separate but allows no option of having the same pasta with different sauces of the consumer's choice or of the sauce amount.

In the Indian granted patent, IN258394, noodles are pre-cooked in boiling water in which a lot of oil (3-8%) is added. The cooked, drained noodles are then smothered with 25-35% additional oil and packed into flexible pouches with other desired ingredients. The filled pouches are then heated to 212° F. followed by sterilization at 240-250° F. at 15-20 psig pressure. The heating at 212° F. step is only to provide gradual heating toward sterilization temperature, as the noodles are pre-cooked before being filled into the pouches. With so much added oil, the void space between noodles is all filled with oil rather than air which is not normal. It may also be contemplated that filling of such oil smothered noodles into pouches, which generally require oil free sealing area, is problematic.

European Patent Application EP0475643 A1 teaches about a process for retorting rice or pasta containing food products. The process includes immersing parboiled rice or uncooked pasta in hot water for a time sufficient to only partially gelatinize the starch granules. This partially gelatinized rice or pasta is then sealed and retorted with extended time at about 210° F., to complete the hydration step before sterilization. In reality, the degree of hydration achieved in the blanching step may vary widely. This causes the water requirement for the completion of hydration to vary widely, making it difficult, if not impossible, to achieve uniformity of the final product. Further as in earlier references, the void space between particles of rice or pasta is filled with liquids rather than air, which is considerably different than an expertly prepared dish.

Yet another technique used by some processors utilizes what is known in the industry as ‘agitating’ or ‘rotary’ retort as against a ‘still’ retort. The agitating retorts allows the food particles being cooked and sterilized, with the water needed for full cooking or hydration, move and mix inside the container. A very recent development in the industry is the ‘addition of dwell time’ to agitating retorts, that gently rock the package to keep the ingredients mixed, while giving some hold time at the end of each oscillation. In a technical review article for Stock America® SWS sterilizers, a retort vessel is described with some exemplary retorting processes. A flexible pouch, looking like a pillow is shown, filled with liquid, while particulate solids are at the bottom. Further there is a small ‘headspace or air bubble’ provided near the top. Very little free space, just the bubble volume, is available for the particulates to swell while cooking. The pouch cannot swell because of the high external pressure used in retorting. Thus, agitation with or without ‘dwell’ can mix the ingredients while there is free fluid in the package, but those actions cannot provide space for the particulates to swell, which must therefore, mush into each other, unless adequate free air is included in the container.

As the above situations put forth, the prior-art processes for preparing retorted food products generally leads to a sticky or lumpy texture for final food products in the container, especially in case when the retorted food products includes starch based food products. It may be realized that the sticky or lumpy texture may primarily be due to the direct sterilization of the retort container and the lack of free space for the starch based ingredient particulates to swell inside the container. It will be desirable to have shelf-stable starch based food products fully cooked with free flowing grains or separate strands rather than lumps. The present disclosure aims to overcome the shortcomings of the prior-art processes for preparing such shelf-stable food products with no or minimal sticky or lumpy texture for the food product, like carefully prepared foods at home or served in any restaurant.

### SUMMARY

In one aspect, the present disclosure provides a method for preparing a shelf-stable starch based food product. The method includes introducing a quantity of a starch based ingredient and other ingredients including water, as required by a recipe, in a container. The method further includes sealing the container with a volume of one or more gases present therein such that the volume of one or more gases adapted to be based on the quantity of the ingredients inside the container. The method also includes processing the container, at a first temperature and a first pressure, for substantially cooking the ingredients inside the container. The method further includes processing the container, at a second temperature and a second pressure, for substantially sterilizing the contents, including the ingredients and the gases, inside the container.

In other aspect, the present disclosure provides a method for preparing a shelf-stable starch based food product. The method includes introducing a quantity of a starch based ingredient and other ingredients including one or more of water, vegetables, proteins, oils, seasoning, emulsifiers and salts, as required by a recipe, in a container. The method further includes sealing the container with a volume of one or more gases present therein such that the volume of one or more gases is based on the quantity and a type of the ingredients inside the container. The method also includes processing the container, at a first temperature and a first pressure, for substantially cooking the ingredients inside the container. The method further includes processing the container, at a second temperature and a second pressure, for substantially sterilizing the contents, including the ingredients and gases, inside the container. The method provides that processing the container is adapted to substantially absorb the water by the ingredients, which lead to an expansion of the ingredients inside the container. The method provides that the volume of one or more gases is sufficient to adjust for the expansion of the ingredients inside the container. The method further provides that the volume of one or more gases is sufficient to fill voids formed due to the expansion of the ingredients inside the container.

In yet another aspect, the present disclosure provides a retort container for a shelf-stable starch based food product. The retort container includes a quantity of a starch based ingredient and other ingredients including one or more of water, vegetables, proteins, oils, seasoning, emulsifiers and salts, as required by a recipe. The retort container further includes a volume of one or more of gases based on the quantity and a type of the ingredients. The retort container also includes a seal to contain the ingredients and the gases inside the retort container. The retort container is subjected to processing at a first temperature and a first pressure for substantially cooking the ingredients, and further subjected to processing at a second temperature and a second pressure for substantially sterilizing the ingredients. The processing of the retort container is adapted to substantially absorb the amount of water by the ingredients, which in turn lead to an expansion of the starch based ingredient inside the container. In the retort container, the volume of one or more gases sealed inside is sufficient to adjust for expansion of the ingredients inside the retort container. In the retort container, the volume of one or more gases sealed inside is further sufficient to fill voids formed due to the expansion of the ingredients inside the container.

### BRIEF DESCRIPTION OF THE DRAWINGS

FIG. 1 illustrates a flow chart illustrating the method for preparing starch based food product, in accordance with an embodiment of the present disclosure.

### DETAILED DESCRIPTION

Detailed embodiments of the present process for preparing shelf-stable starch based food products are disclosed herein; however, it is to be understood that disclosed embodiments are merely exemplary of the present disclosure, which may be embodied in various alternative forms. Specific process details disclosed herein are not to be interpreted as limiting, but merely as a basis for the claims and as a representative basis for teaching one skilled in the art to variously employ the present disclosure in any appropriate process for preparing similar food products.

The present disclosure provides a process for preparing a shelf-stable food product. Shelf-stable food products, also sometimes known as retorted food products, are processed food products which may be safely stored at room or ambient temperature for a usefully long shelf life. Such food products with proper packaging may last for an extended period at room temperature without spoiling. Various processing methods including food preservation techniques and packaging techniques have been devised to extend a food's shelf-stable life. Basically it is achieved by sterilizing the contents inside the container, including food ingredients and gases therein, a process also known as commercial sterilization. Usually, for commercial production, the sterilizing step is performed by processing the container having the ingredients in a retort vessel.

According to an embodiment, the present disclosure particularly relates to a process for preparing shelf-stable starch based food products. The primary ingredient for the present starch based food products includes a starch based ingredient, such as, but not limited to, raw rice or raw pasta. For the purpose of the present disclosure, the term “starch based ingredient” is used to refer to the primary starch ingredient packed in a container along with other ingredients, and the term “starch based food product” is used to refer to the final processed food product packed in the container. Further, the terms “starch based ingredient” and “starch ingredient”; and the terms “starch based food product” and “food product” are interchangeably used in the present disclosure. The present disclosure provides method for preparing food products, especially rice and pasta products, and its various blends with other ingredients; such as pastas like macaroni, fusilli, vermicelli, spaghetti, ziti, beans or couscous that are ready for serving with sauces and seasonings, singly or in various blends.

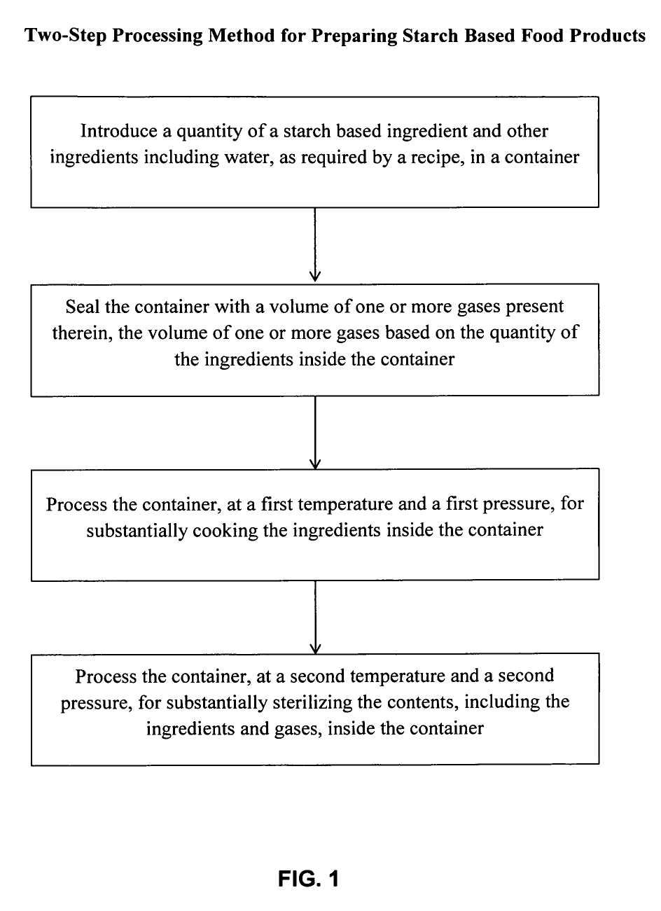

FIG. 1 illustrates a general flow diagram highlighting various steps involved in the method of the present disclosure. In an embodiment, the present method includes introducing a quantity of a starch based ingredient in a container. As discussed, the starch ingredient may be rice or pasta, or any other starch ingredient based on the to-be-prepared food product. The quantity of the starch ingredient in the container may be determined by the packaging requirement, that is, for example a single serving of food product, 500 grams of food product or any other possible quantity allowed by the container size and/or processing steps of the present disclosure. It may be contemplated that the quantity of the starch ingredient may depend on the requirements of the recipe chosen for preparing the final food product.

In an embodiment, the method of the present disclosure further includes introducing a quantity of other ingredients in the container. The other ingredients may include one or more of water, vegetables, beans, grains, proteins, oils, emulsifiers, seasoning and salts. These ingredients may be suitably selected based on the recipe for preparing the food product. For example, the vegetables, grains, and proteins like meats or soya items may be added to add flavor and nutrient value; oils may be added for proper cooking of the starch based ingredient; emulsifiers may be added for mixing of oils with the water content, and seasoning and salts may be added to vary taste of the final food product. In some embodiments, these ingredients may be suitably selected based on the processing steps utilized in the present disclosure. However it may be understood that processes of the present disclosure do not particularly limit any ingredients which could normally be employed with the food retorting processes known in the art.

It may further be understood that the quantity and type of other ingredients may vary as per the recipe. In accordance with an embodiment, the starch ingredient may act as a base ingredient based on which the quantity of other ingredients may be determined. As may be contemplated by a person skilled in the art of cooking, the quantity of other ingredients may be calculated as per the ratios defined by the recipe for the starch ingredient to other specific ingredients. In an embodiment, the method of the present disclosure includes introducing an amount of water in the container along with the starch ingredient. As discussed, the amount of water may be determined based on a defined ratio of the starch ingredient content to the water content as defined by the recipe.

Since the ingredients are filled mostly in a raw form inside the container, these ingredients are required to be processed in order to be stored in a ready-to-eat product form. It may be contemplated by a person skilled in the art that during processing, the ingredients tend to absorb more and more water present inside the container. As a result, the ingredients, especially the starch ingredient, tend to expand inside the container. In an embodiment, the present disclosure provides that a volume of one or more of gases may be present in the container. The volume of gases provides the headspace for expansion of the ingredients inside the container. In an embodiment, the volume of gases may be suitably sufficient to adjust for the expansion of the ingredients. Further, in an embodiment, the volume of gases may be sufficient to fill voids formed due to the expansion of the ingredients inside the container. It may be understood that the volume of gases inside the container indirectly create ample free headspace therein, as the gases move to fill the voids formed by the expansion of ingredients.

It may be understood by a person skilled in the art that the volume of one or more gases may depend on the quantity of the ingredients inside the container. For example, the more the quantity of the ingredients inside the container, the more would be the volume of expansion of the ingredients; and therefore more volume of gases would be required to adjust against the expansion. Further, the volume of one or more gases may depend on the type of the ingredients inside the container. For example, the void space formed between the starch ingredient particles upon processing depends largely upon the species of the ingredient, like rice or pasta, etc., and since the volume of gases would have to be sufficient to fill the voids formed inside the container, the volume of required gases have to be varied with the type of the ingredients. In an exemplary embodiment, the void space in expertly prepared fresh rice and pasta dishes has been measured to be between around 45-50% for rice and 50-55% for various pastas. Accordingly, it may be understood that the preferred volume of gases in a sealed container should be close to the volume of all the ingredients combined, with more volume of gases being more preferable.

In a preferred embodiment of the present disclosure, the one or more gases may be simply air. As the air is naturally utilized in conventional cooking, the same may be suitable for most typical retorting processes. In an alternative embodiment, the gas used may be one of the inert gases like nitrogen. The inert gas does not react with the chemicals in the ingredients and thus may lead to longer shelf life for the food product. In another alternative embodiment, the one or more gases may be carbon dioxide or any other commonly used packing gas. In yet another embodiment, the one or more gases may be a mixture of nitrogen, carbon dioxide and the like.

The ingredients in their respective quantities as prescribed by the recipe are filled in the container. In an embodiment, the container employed for packing the ingredients may be a retort container. The retort containers are specially designed to stand up to high temperature and pressure conditions required for the processing of the ingredients therein. In food retorting industry, the retort containers are mostly processed in a retort vessel, especially for the process of sterilization. The retort vessels provide the fixed temperatures and pressures conditions required for processing the ingredients packed in the container. It may be contemplated that the size of the container employed may be based on the quantities of the ingredients to be filled therein.

Further it may be contemplated that the type of the container employed may be influenced by the processing steps for preparing the food product. The retort containers are available in various forms and shapes. In an embodiment, the container may be one of a flexible pouch, a semi-rigid cup or tray, or a substantially rigid can. In a preferred embodiment, the container is a flexible pouch. The flexible pouch could swell like a balloon due to the created internal pressure as a result of supplied heat while processing. This creates a lot of free space for the contained ingredients to expand freely as desired by the embodiments of the present disclosure. In semi-rigid or rigid containers, which do not change much in size during processing, the containers are designed so that the ingredient particles after being filled therein have enough empty headspace for the volume of required gases and adjusting against the expansion of the ingredients.

The method of the present disclosure further includes sealing the container with the ingredients, including the starch ingredient and other ingredients, and the volume of one or more gases present therein. The seal is provided to prevent the escape of the packed contents inside the container, including the ingredients and gases, and also the entry of any new bacteria or other contaminants inside the container. In an embodiment, the seal is provided in a manner to ensure that there is sufficient headspace above the ingredients to allow for its expansion inside the container. In an embodiment, the type of seal used may vary widely with the type of the container employed for packing the ingredients. For example, a retort pouch may be sealed using a heat seal or the like, a retort cup or a retort tray may require a heat sealed film, a seamed metal lid or the like, while a retort metal can may require a double-seamed metal lid or the like. In a preferred embodiment, the retort pouch employed as the container for packing the ingredients in the present disclosure is sealed using a heat or other means.

In an embodiment, the method of the present disclosure includes processing the container with the ingredients present therein. Specifically, the present method includes thermally processing the container for preparing the food product. In an embodiment, the present method is a two-step processing method, such that the two processing steps are carried out in different temperature and pressure conditions. In an embodiment, the first processing step may be devised in order to cook the ingredients inside the container and the second processing step may be devised to subsequently sterilize the ingredients inside the container. In particular, the first processing step includes subjecting the container to a first temperature and a first pressure conditions in order to sufficiently cook the ingredients inside the container. Further, the second processing step includes subjecting the container to a second temperature and a second pressure in order to completely sterilize the contents, including the ingredients and gases, inside the container. Hereafter, the first processing step is referred to as “cooking step” and second processing step is referred to as “sterilization step” respectively.

In an embodiment, the cooking step may be carried out at temperatures and pressures comparable to those employed in conventional home cooking. These low temperature and pressure conditions help to keep the starch ingredient particles separate, like those prepared by careful home cooking. In an embodiment, the first temperature is in the range of 180 degrees to 230 degrees Fahrenheit. Preferably, the first temperature is in the range of 200 degrees to 220 degrees Fahrenheit. More preferably, the first temperature is 212 degrees Fahrenheit. Further in an embodiment, the first pressure is in the range of 0 to 20 pounds per square inch on the gauge scale (psig). Preferably, the first pressure is in the range of 0 to 10 psig. More preferably, the first pressure is in the range of 0 to 5 psig.

The sterilization step may be carried out at higher temperatures and higher pressures compared to those employed in the cooking step. In an embodiment, the second temperature is in the range of 230 degrees to 260 degrees Fahrenheit. Preferably, the second temperature is in the range of 245 degrees to 250 degrees Fahrenheit. More preferably, the second temperature is 248 degrees Fahrenheit. Further in an embodiment, the second pressure is in the range of 20 to 50 pounds per square inch on the gauge scale (psig). Preferably, the second pressure is in the range of 30 to 40 psig. More preferably, the second pressure is in the range of 30 to 35 psig.

In an embodiment, the two steps of processing the container may take place in a single retort vessel. The retort vessel's settings may be adjusted to vary the required temperature and pressure conditions for the two different processing steps. In an alternative embodiment, the two processing steps takes place in separate vessels. The cooking step may take place on a regular stovetop or any other setup/device which can provide the required first temperature and first pressure for cooking the ingredients inside the container. And, the sterilization step may be carried out in a retort vessel to attain the high temperature and high pressure demand.

### INDUSTRIAL APPLICABILITY

Aspects, advantages and/or other features of exemplary embodiments of the disclosure will become apparent in view of the following description, which discloses various non-limiting embodiments of the disclosure. It is to be understood that specific examples may include all technical equivalents that operate in a similar manner to accomplish a similar purpose. Further individual features described for one embodiment may be combined with individual features described for other embodiments. Also some features as shown or described in the context of functional segments may be omitted within the scope of the present disclosure.

The conventional home cooking generally employs a pot with all the ingredients placed on a stovetop which provides the heat for cooking. When the temperature reaches around the boiling point of water, heating is continued till almost all the free water gets absorbed by the ingredients and at that point the ingredients are sufficiently cooked. Generally at this point, the heat source is reduced or turned-off, otherwise the rising temperature at the bottom of the pot may cause sticking and lumping of the starch ingredient particles.

In known retorting methods, the containers in retort vessels are heated from initial temperatures of around 90-120° F. to the high temperatures of about 240-250° F., as required for sterilization. The containers are then held at those high temperatures for a required duration to achieve full cooking and commercial sterility. In such process, the ingredients get cooked at the same time while being sterilized in the retort vessel. It may be realized that the ingredients inside the container could already be sufficiently cooked while the container may still being subjected to high sterilization temperatures and pressures for extended period. The longer exposure to high retort temperature may lead to sticking of the starch ingredients. In some cases, there might even be a risk that the food product may get charred because of prolong exposure to high sterilization temperature over the extended period.

Also in households, pastas are normally cooked in large excess of water, so that the temperature remains at the boiling point of water and the ingredients remain separate until cooked. Similarly rice may also sometimes be cooked in excess of water. When sufficient cooking is achieved, the pot is removed from heat and excess water is drained. The use of excess water prevents bonding and clumping of ingredients while preparation. However such use of excess water which is subsequently drained cannot be practiced in retort packaging methods. Food products in retort containers have to be cooked in the exact amount of water as needed by the recipe.

The known single step retorting process does not permit all the water content present in the container to get sufficiently absorbed by the ingredients before the ingredients are subjected to high sterilization temperatures. So there could be some free water left standing along with the starch ingredients inside the container at sterilization temperature. As cooking proceeds, some starch leaches out into the free water and causes the water phase to get increasingly thicker and sticky. The starch ingredients when in contact with this sticky free water produce a lumpy texture in the final food product.

Further, the retort processing is required to be performed at high external pressures for protecting the container against failure due to high internal pressure developed by the expansion of the ingredients inside the container. The use of high external pressures in the retort vessel causes the retort container to contract, especially when the flexible retort pouches are employed as container for the ingredients. As no means are taken to provide sufficient headspace, this contraction of the container reduces the already insufficient free space inside the flexible retort containers. The reduced free space makes it difficult for the ingredients inside the container to swell as the water gets more and more absorbed. Thus the ingredient particles are forced closer and closer to each other inside the container. Because of the sticky nature of the starch ingredients, there would be more bonding of the ingredient particulates. This external overpressure during retorting may therefore lead to food product with considerable bonding of ingredient particles inside flexible containers.

The particulate bonding and lumpy texture makes the commercially available flexible pouches of starch based food products to look and feel like bricks. Such food products, when taken out of the container look less attractive than similar food carefully prepared fresh in a pan on stovetop cooking. The present disclosure provides a method which includes two-step processing of the ingredients for preparing shelf-stable starch based food product with superior looks and texture than are produced with the currently used retort based technologies.

The cooking step is devised to subject the container containing all the required ingredients to cooking conditions that resemble conditions in stove top cooking, that is, temperature close to normal boiling point of water (at closer to atmospheric pressure); ample free headspace for the ingredient to cook while absorbing water and expanding without space restriction; and with sufficient volume of gases present in the container to fill the void spaces formed between the ingredient particles. There is no significant rise in temperature of the present container even after all the water is absorbed, as the first processing temperature is maintained at close to the normal boiling point of the water. Further the cooking step takes place under minimum external pressure necessary to protect the container seals from failing due to increase in internal pressure as a result of supplied heat. Further such low external pressure allows containers like flexible pouches to swell like balloons because of internal pressure, creating a lot of free space for the contained ingredients to expand freely while cooking.

Since the ingredients from the cooking step would already be at higher temperature, the time period required to achieve sterilization may be significantly reduced. Therefore, the container is required to be subjected to high temperature and pressure of sterilization step for a much shorter period that is only enough for sterilizing the ingredients inside the container. For example, the container may be at about 212° F. after the cooking step which effectively becomes the initial temperature for the sterilization step, as against 90-120° F. in currently used retorting. Thus the time required to reach the full sterilization of contents inside the container may be significantly reduced. It may be contemplated as the ingredients are exposed to higher temperatures for much shorter duration, this may reduce the chances of ingredient particulates sticking to each other.

Further, it may be understood that almost all of the free water may be absorbed by the time, the cooking step is completed. The present method may therefore ensure that the container when subjected to sterilization step contains little or no free water as compared to conventional retorting methods in which the ingredients have not been pre-cooked. This may eliminate the cause of the lumpy texture of the ingredient particles inside the container for the final food product.

As could be construed from the above discussions, the present method produces food products with no or minimal particulates sticking or lumping. This was achieved because of the method utilized two-step processing involving the cooking step followed by the sterilization step. This is further achieved due to the presence of volume of gases which is adapted to fill the formed voids and also provide headspace for free expansion of the ingredients inside the container. The present method, therefore, produces the exquisite looking shelf-stable food products that are more attractive than other retorted products available in the market, and comparable to food products cooked at home or served in some restaurant.

The present method may be implemented in almost all facilities that make retorted, shelf stable foods in any type of container, without requiring any new equipment or major changes in the manufacturing process. Further since the present method provides that the starch ingredients may be filled in dry state, it becomes easier to keep the seal area clean while filling, and thus provides proper sealing of the container as well. An added advantage is that since the cooking occurs in a sealed container so none of the flavors and aromas could escape, as happens on stove top cooking.

It has been measured that the void space in expertly prepared fresh rice and pasta dishes is generally between around 50% for long grain rice and 60% for various noodle pastas. Accordingly, the preferred air volume in a sealed container before any processing should be close to the volume of all the ingredients combined, with more air being more preferable. In an exemplary embodiment, the present disclosure provides that 90 g of Sella rice with packing density of about 0.78 g/ml and 120 g of water were placed in a pouch, and sealed at the open end without squeezing out free air. The combined volume of the rice and water was about 190 ml. Further, the contained air volume was measured via water displacement to be about 194 ml. In other exemplary embodiment, the present disclosure provides that 100 g of Sella rice with packing density of about 0.78 g/ml and 130 g of water were placed in a pouch, the open end of which was sealed without squeezing out free air. The combined volume of the rice and water was measured to be about 208 ml. Further, the volume of contained air was measured via water displacement to be about 222 ml. It may be realized that normal packaging arrangement in which the air is not squeezed out, the volume of air present inside the container may be sufficient as per the embodiments of the present disclosure.

The following exemplary experiments were carried out to check the efficacy of the presently disclosed method. Further some examples are provided for comparison between the present method and the conventional retorting methods known in the art. In the exemplary embodiments, the containers employed are flexible pouches, or more specifically multi-layered transparent, gusseted bags. Alternatively, the commercial #300 cans with 3″ diameter×4.43″ height, and approximately 514 ml of internal volume were employed. The containers were sealed with air inside. The seal area may take up some of the volume inside the container. As provided in the embodiments of the present disclosure, the volume of provided air is ensured to be sufficient to provide the headspace for expansion and fill the voids as the starch ingredient particles swell while cooking. In sealed pouches, the total volume of all the ingredients combined was generally about 200 ml and that of contained air was approximately a little over 200 ml, as preferred by the embodiments of the present disclosure.

### Example 1

To a commercial, transparent retort pouch were added par-boiled Basmati rice (commonly called ‘Sella’ rice) freshly chopped onion, butter, salt, overnight soaked kidney beans and water. A second similar pouch was filled with same components, except the kidney beans were replaced with overnight soaked garbanzo beans. The open ends of both pouches were heat sealed, without squeezing free air from the pouch. In a 20 quart pressure cooker with water to about 3″ height, the two sealed pouches were placed on a perforated plate positioned above the water level. The pressure cooker was covered loosely with its cover, without the pressure control weight on the top nozzle, so no significant pressure could develop in the cooker when water was boiled. The cooker was heated to bring the water to vigorous boil so steam could be seen escaping from the sides of the loose cover and also from the top nozzle. After 30 minutes of steaming the pouches, heat was turned off and the cover removed. Visual examination of the subject pouches, which were swollen like balloons while still in the pressure cooker, after removal from the cooker showed rice grains in both pouches appearing to be fully cooked with very minimal lumping of the final food products. These pouches appeared perfect for retorting for sterilization to achieve shelf stability.

### Example 2

Having learned from example 1 that boiling water temperature can cook rice and other components very well without causing lumping, several sealed, transparent pouches, 14 in all, were made with rice as the main component (50-99% on water free basis) in different recipes. Water was added in each recipe based on the rice content to fully hydrate the rice. An open top vertical, still retort, with steam injection port in the bottom, was filled with water to about 3 feet. Steam was turned on to heat and violently agitate the water till water started to boil. All 14 pouches were placed in a retort basket, which was lowered into the retort, such that there was about 1 foot water in the basket and all pouches were floating in the agitating, boiling water, which was measured to be at 201-208° F. with a thermocouple taped to one of the pouches. Actual water temperature may have been closer to its boiling point at 212° F. After 20 min of immersion in boiling water, the basket was lifted out and none of the pouches had failed, even though the pouches were swollen like balloons at the seams. All pouches were transferred to an FMC® Steam Water Spray (SWS) retort and retorted for a 32 min cook time cycle at 35 psig pressure and 248° F., approximating the time required for full sterility. Visual examination of retorted, cooled pouches showed no significant lumping, and upon opening a few pouches, the contents were found to be easily separable into single grains. Thus, shelf stable, retorted pouches containing rice as the major component (up to 99%) were produced with no lumping or bonding of the rice grains.

### Example 3

Example 2 showed that the rice products in sealed flexible pouches can be processed in boiling water, keeping the pouches tumbling and contents well mixed; producing cooked rice foods without the lumping of rice grains. It became important to determine what role was played by the tumbling or agitating action played in keeping the grains separate and not lumpy. A setup was devised including a shallow, long but narrow tank commonly used in the food industry to clean food transfer pipes and known as Clean-Out-of-Place (COP) tank. Such tank produces very vigorous circulation of water using jets from both ends. The tank was setup and filled with water. Steam was injected via a long perforated pipe held near the tank bottom to heat the water and bring it to atmospheric pressure boiling. A wire mesh basket with ½″×½″ openings was held immersed and stationary in the boiling, circulating water, which circulated through the baskets as well because of the large mesh openings.

Eight numbers of flexible pouches were filled with two different rice blends (four with Sella rice, roasted corn and red pepper, onion, butter and seasoning; the other four with Brown Basmati, onion, lentils, mushrooms, olives, olive oil and seasoning) and water was added to the pouches to allow for full hydration. Total fill weight in the pouches was about 8 oz. Further eight numbers of metal cans were also filled, four each of the two blends and the necessary amount of water, total fill weight per can being 6.2 oz. so there was enough free head space that the rice grains did not have to be mushed by each other even after full cooking. Four each of the pouches and cans were tied firmly within the basket, making those immobile and thus without any agitation. Four each of the pouches and cans were placed outside the basket and were free to float and tumble in boiling water by the vigorous agitation. All cans and pouches remained in boiling water for 30 min, after which all were taken out of the COP tank, and processed in the SWS retort for 28 min cook time at 248° F.

The difference in the final retorted products from the agitated vs. un-agitated pouches and cans was minor, with the agitated pouches looking slightly better with almost no sticking. It was concluded that if agitation was available during the cooking step, it should be used, but if not available even then decent food products could be made without agitation. The lack of any major improvement with agitation was not surprising as the usefulness of agitation continually diminishes as cooking proceeds making the remaining water thicker and the cooked grains less mobile.

### Example 4

Example 3 taught us that tumbling or agitation made only minor improvement in the finished rice product quality, especially regarding lumping and sticking of the grains. Accordingly, another test was performed in which sealed containers of rice products in stationary state were heated with live, atmospheric pressure steam with no forced tumbling or agitation.

Two pouches and three cans were filled and sealed with a blend of Sella rice, corn, black eyed peas etc. and the containers were placed in the basket of vertical, still retort with steam injection port in the bottom. The basket was lowered into the retort and the lid was closed but not tightened, and the vent line was left open so the vessel could not be pressurized beyond a nominal few psig. Steam was turned on to heat the retort without any effort to drive all the air out, and in a few minutes the actual temperature on the thermometer showed 212-213° F., and the pressure gauge showed 2-3 psig pressure, as there may have been some air in the vessel. After 30 min, steam was tuned off, the lid opened and the basket taken out. The rice grains in the clear pouches looked fully cooked but separate and no lumping was observed. Both pouches and the three cans were transferred to a SWS retort and retorted at 248° F. for 28 min. The retorted pouches and cans were examined the next day and showed rice product without any lumping.

This test showed us that some pressure above atmospheric pressure was not harmful. A large number of excellent products of rice blends with different beans and seasonings were made using steam at pressure slightly above atmospheric pressure and temperature close to 212° F. for the pre-cook step, followed by retorting for sterilization in the retorts.

### Example 5

Example 4 taught us that the pre-cook step could be carried out with steam heating at above atmospheric pressure, but close to 212° F. without any detrimental effect of the small overpressure on the finished retorted product. Accordingly, changes were made in the software of our SWS retorts, so that the pre-cook step could be carried out at a modest pressure at 212-215° F. within the SWS retort, the controls of which operated better when the pressure was set at 3 psig than at 0 psig. The software allowed the retort temperature and pressure to rise once the pre-cook step at low pressure was completed, so that the same container without having to be moved was subjected to sterilizing conditions of 20-45 psig pressure and 245-250° F. temperature for the pre-determined time based on heat penetration studies. Thus, the 2-step process could be carried out in situ in the SWS retort, and no transfer of the containers from one unit to another was necessary.

Various rice, rice blends and pasta were processed in pouches and in metal cans in several runs of the SWS retort, with both steps of the 2-step process carried out within the same vessel. The pre-cook step was set for 20 min at 212° F. and 3 psig, the sterilization step was set for 28 min at 250° F. and 32 psig. Very high quality products with minimum or no sticking or bonding of grains or pasta particulates was produced from the flexible pouches as well as from the metal cans that mimicked semi-rigid containers as well. Because of the high initial temperature in the sterilization step, it is possible that the come-up time, the sterilization time and pressure can be significantly reduced to further improve the products while reducing cycle times and energy consumption per cycle.

### Example 6

50 g each of elbow macaroni and spiral pasta were placed in separate metal cans. 90 g of water containing 1.5% salt and 1% calcium chloride, and 3 g of soybean oil were added to the cans which were closed with lids in a can seaming device. The cans were processed via the two-step processing method. The cooked pasta filled the cans to near the top end, and the particles were not lumped. This pasta with a lot of air space available for expansion looked much nicer than a commercially available 3-Cheese Pasta in the market.

### Example 7

50 g of elbow macaroni and 80 g of water with 1.5% salt were placed into 5″×7″ retort pouches and sealed without squeezing out free air. One pouch was processed via conventional retorting method involving single step processing at 248° F. for 32 min. The other pouch was subjected to two-step processing by running the cooking step in a steam chamber at 212° F. and 2-3 psig pressure for 30 minutes, followed by sterilization at 248° F. for 32 min. The macaroni product prepared via two-step processing method had much less sticking of the particles than the conventional retorting method.

### Example 8

Two pouches were made and processed as in example 6, with 50 g of ‘Israeli’ couscous and 120 g of salted water. Again, the two-step processing method produced ready to eat couscous with mostly separate particles while that from the conventional retorting method were mostly stuck together.

Examples and limitations disclosed herein are intended to be not limiting in any manner, and modifications may be made without departing from the spirit of the present disclosure as defined in the appended claims.

1. A method for preparing a shelf-stable starch based food product, comprising the steps of:
introducing a quantity of a starch based ingredient and other ingredients including water, as required by a recipe, in a container;
sealing the container with a volume of one or more gases present therein, the volume of one or more gases adapted to be based on the quantity of the ingredients inside the container;
processing the container, at a first temperature and a first pressure, for substantially cooking the ingredients inside the container; and
processing the container, at a second temperature and a second pressure, for substantially sterilizing the contents, including the ingredients and gases, inside the container.

2. The method of claim 1, wherein the other ingredients further includes one or more of vegetables, proteins, oils, seasoning, emulsifiers and salts.

3. The method of claim 1, wherein processing the container is adapted to substantially absorb the amount of water by the ingredients which leads to an expansion of the ingredients inside the container.

4. The method of claim 3, wherein the volume of one or more gases is adapted to be sufficient to adjust for the expansion of the ingredients inside the container.

5. The method of claim 4, wherein the volume of one or more gases is adapted to be further sufficient to fill voids formed due to the expansion of the ingredients inside the container.

6. The method of claim 5, wherein the volume of one or more gases is adapted to be further sufficient based on a type of the ingredients inside the container.

7. The method of claim 1, wherein the first temperature is in the range of 180 degrees to 230 degrees on the Fahrenheit scale.

8. The method of claim 1, wherein the first pressure is in the range of 0 to 20 pounds per square inch on the gauge scale.

9. The method of claim 1, wherein the second temperature is in the range of 230 degrees to 260 degrees on the Fahrenheit scale.

10. The method of claim 1, wherein the second pressure is in the range of 20 to 50 pounds per square inch on the gauge scale.

11. The method of claim 1, wherein the one or more gases is air.

12. The method of claim 1, wherein the two steps of processing the container takes place in a single retort vessel.

13. The method of claim 12, wherein the two steps of processing takes place in separate vessels, and wherein the processing step for sterilization takes place in a retort vessel.

14. The method of claim 12 or 13, wherein the container is a retort container.

15. The method of claim 14, wherein the container is one of a flexible pouch, a semi-rigid cup or tray, or a substantially rigid can.

16. The method of claim 14, wherein the container is a flexible pouch.

17. A method for preparing a shelf-stable starch based food product, comprising the steps of:
introducing a quantity of ingredients, including a starch based ingredient and one or more of water, vegetables, proteins, oils, seasoning, emulsifiers and salts, as required by a recipe, in a container;
sealing the container with a volume of one or more gases present therein, the volume of one or more gases adapted to be based the quantity and a type of the ingredients;
processing the container, at a first temperature and a first pressure, for substantially cooking the ingredients inside the container; and
processing the container, at a second temperature and a second pressure, for substantially sterilizing the ingredients and gases inside the container;
wherein processing the container is adapted to substantially absorb the amount of water by the ingredients which leads to an expansion of the ingredients inside the container; and
wherein the volume of one or more gases is adapted to be sufficient to adjust for the expansion of the ingredients inside the container and further adapted to be sufficient to fill voids formed due to the expansion of the ingredients inside the container.

18. The method of claim 17, wherein the first temperature is in the range of 180 degrees to 230 degrees on the Fahrenheit scale and the first pressure is in the range of 0 to 20 pounds per square inch on the gauge scale, and wherein the second temperature is in the range of 230 degrees to 260 degrees on the Fahrenheit scale and the second pressure is in the range of 20 to 50 pounds per square inch on the gauge scale.

19. The method of claim 17, wherein the container is one of a retortable flexible pouch, a retortable semi-rigid cup or tray, or a retortable rigid can.

20. A retort container for a shelf-stable starch based food product, comprising:
a quantity of ingredients, including a starch based ingredient and one or more of water, vegetables, proteins, oils, seasoning, emulsifiers and salts, as required by a recipe;
a volume of one or more of gases adapted to be based on the quantity and a type of the ingredients; and
a seal to contain the ingredients and the gases inside the retort container;
wherein the retort container is subjected to processing at a first temperature and a first pressure for substantially cooking the ingredients, and further subjected to processing at a second temperature and a second pressure for substantially sterilizing the ingredients and gases, processing the container is configured to substantially absorb the amount of water by the ingredients which leads to an expansion of the starch based ingredient inside the container; and
wherein the volume of one or more gases is adapted to be sufficient to adjust for expansion of the ingredients and further adapted to be sufficient to fill voids formed due to the expansion of the ingredients inside the retort container.
